(19) United States
(12) Patent Application Publication
(10) Pub. No.: US 2022/0297009 A1
(43) Pub. Date: Sep. 22, 2022

(54) PORTAL UNIT FOR TOYS, SYSTEM AND METHOD FOR USING A PORTAL UNIT

(71) Applicant: Geobra Brandstaetter Stiftung & Co. KG, Zimdorf (DE)

(72) Inventor: Frank Mueller, München (DE)

(73) Assignee: Geobra Brandstaetter Stiftung & Co. KG, Zirndorf (DE)

(21) Appl. No.: 17/689,432

(22) Filed: Mar. 8, 2022

(30) Foreign Application Priority Data
Mar. 19, 2021 (DE) 102021106803.7

(51) Int. Cl. A63F 13/65; G06F 3/041; A63F 13/235; A63H 3/36; A63H 30/04

(52) U.S. Cl. CPC A63F 13/65; G06F 3/041; A63F 13/235; A63H 3/36; A63H 30/04; A63H 2200/00; A63F 2300/69; A63F 2300/1031

(57) ABSTRACT

A portal unit for toys, the portal unit having a housing, a display apparatus that is arranged at a portion of the housing, a receptacle for at least one toy, and a toy recognition device. In embodiments, the display apparatus has a liquid crystal display and a background illumination device; wherein the liquid crystal display is transparent; wherein the display apparatus forms an interior space, of which at least one inner wall is visible from the outside; and wherein the background illumination device is arranged at a distance from the liquid crystal display on a rear wall of the interior space.

### CROSS-REFERENCE TO RELATED APPLICATIONS

This application claims priority to German Patent Application No. DE 10 2021 106 803.7, filed Mar. 19, 2021, the contents of which are hereby incorporated by reference in its entirety.

### TECHNICAL FIELD

The invention relates to a portal unit for toys, and to a system and to a method for using a portal unit.

### BACKGROUND

Portal units for toys, systems, and methods for using portable units are known, in part, in the prior art.

With continually increasing computational power, expanded possibilities owing to the use of artificial intelligence, and cheaper hardware, applications of virtual reality find an increasing number of users in the professional and private areas, including the area of recreational activities. For example, it is known to use a mobile telephone or a portable tablet, which frequently has no keyboard, to record images of a surrounding area using an integrated camera, to identify surfaces, contours and in part objects in said surrounding area, and to use these pieces of information to compute virtual images that are displayed in the correct position on a screen of the corresponding devices. For example, it is possible to supplement real camera images with virtual contents. This can be done both for application purposes and for playing purposes. However, the corresponding systems require some pre-existing knowledge and experience when handling the technical device used. However, this experience is generally not existent in children.

KR 20160027384A discloses a presentation apparatus for shop windows, having a transparent display and a background illumination device, wherein the display and the background illumination device are arranged at a distance from one another. The transparent display in this case is arranged between a viewer and the background illumination device.

Consequently, it is an object to specify new playing options using concepts of virtual reality for a user group without experience, wherein the playing options are intended to be easy to use and to thus allow the relevant target group to use interactive possibilities for getting to know virtual reality and for playing therein.

Such object may be achieved by a portal unit for toys according disclosed embodiments, a system of at least one portal unit and at least one toy according to disclosed embodiments, and a method for using a portal unit according to disclosed embodiments. Continuative configurations are also disclosed herein.

### SUMMARY

The invention describes a portal unit for toys, wherein the portal unit has a housing, wherein a display apparatus is arranged at the housing, wherein the display apparatus has a liquid crystal display and a background illumination device, wherein the liquid crystal display is transparent, wherein the display apparatus forms an interior space, of which at least one inner wall is visible from the outside, wherein the background illumination device is arranged at a distance from the liquid crystal display on a rear wall of the interior space, wherein the portal unit has a receptacle for at least one toy and a toy recognition device.

Embodiments of a housing can have a generally cuboid design and have six housing sides. According to one variant, the housing can primarily comprise a plastics material, which can, among other things, be injection molded. The housing can be disassembled, be protected against impact and splash-proof and be colored in different colors. A power connection can be provided at the housing. A battery or battery compartment may be arranged in the housing.

The display apparatus can be arranged on one of the housing sides of the housing and cover some, most or all of it. The display apparatus can be recessed into the housing, with the result that a front side of the display apparatus facing the outside is flush with the corresponding housing side of the portal unit or is recessed with respect to it.

Owing to the fact that the display apparatus forms an interior space in which the background illumination device is arranged at a distance from the liquid crystal display on a rear wall of the interior space, it is possible for a presentation generated by the liquid crystal display to give an impression of depth that has a hologram-like effect and thus creates increased plasticity and an enhanced sense of reality.

A holographic effect can be intensified in particular if the presentation to be displayed is positioned such that it appears to be positioned in relation to an inner wall. For example, a playing figure arranged on a bottom of the interior space gives the impression that the playing figure is standing in the interior space. The holographic effect can graphically be intensified by the display apparatus simulating shadows.

The shadows can be presented on the bottom and, depending on the simulated illumination situation and the size of the presented object, in part on the rear wall or the background illumination device. If a user of the portal unit views the display apparatus from an appropriate angle from slightly above the presentation, a distinct three-dimensional effect can be attained.

Owing to the fact that the portal unit has a receptacle for at least one toy and a toy recognition device, it is possible to recognize the toys of the users of the portal unit. In that case, a virtual reproduction of the toy, referred to below as “virtual toy”, can be presented on the display apparatus. The virtual toy can, among other things, be integrated in videos, it can be moved or modified and so on.

This produces the impression for the user, in particular for children, as if the toy that has been placed into the receptacle is ported into virtual reality, which opens up a wide variety of playing options.

In a first continuative configuration, the display apparatus can have at least one switchable polarization filter.

Use of at least one switchable polarization filter makes it possible to enhance the contrast of the display apparatus by dimming the background illumination device in specific regions. As a result, a wide variety of scenes may be presented and the application range of the portal unit may be increased.

In a further continuative configuration, the portal unit may have a computational unit for controlling the display apparatus and/or the toy recognition device.

The computational unit can have a processor and a non-volatile memory. An operating system in addition to necessary display software, for example for the interpretation and reproduction of image and video data, can be stored in the non-volatile memory for operating the portal device. Furthermore, a database having various toys and their graphical presentations can be stored in the non-volatile memory. Moreover, data for application options relating to the toys can be stored. The use of such a computational unit allows the calculation of virtual presentations, a manipulation and the reproduction of videos based on the recognized toy(s).

In a further continuative configuration, the toy recognition device can have at least one of an NFC scanner, a camera, an optical scanner and/or a near field communication apparatus.

NFC (near field communication) is a known abbreviation for near field communication systems. NFC is an international transmission standard, based on RFID (radio frequency identification) technology, for the contact-free exchange of data by electromagnetic induction using loosely coupled coils over short distances. Such distances are typically distances of a few centimetres. The use of an NFC scanner allows the reliable recognition of toys provided with an NFC tag (NFC sticker). NFC has the advantage that the technology needs to be supplied with power only on one side, and the NFC tags consequently require no energy storage device. In addition, NFC tags are cost-effective and can be arranged inconspicuously.

Radio communication options are also possible, for example Bluetooth, in particular low-energy consumption standards.

Cameras and other optical scanners permit optical recognition methods without any absolute need of special stickers, but they may have a low recognition accuracy under certain circumstances, in particular in the case of modified toys. In optical methods it is possible to increase the recognition accuracy by using optical codes. In one variant, such codes can be QR codes; in another variant, they can be inconspicuous optical features such as patterns or a structure.

In a further continuative configuration, a distance between surfaces that are aligned with respect to one another between the background illumination device and the liquid crystal display may be between 1/10 and ¾ or ¼ and ½ or ⅓ of the height of the liquid crystal display.

With such a distance, it is possible to achieve a sufficiently large three-dimensional or holographic effect.

In a further continuative configuration, the portal unit can have an interface with a computer, via which data are transmittable bidirectionally between the computer and the portal unit.

Such an interface can be wireless and/or have a wired design. In various variants, interface standards or communication standards such as USB or WLAN, Bluetooth or the like can thus be used for communication and for the data exchange. According to one variant, the portal unit can make itself known as such. Corresponding drivers can be stored in the non-volatile memory and be transmitted at least in the case of the first coupling between the computer and the portal unit.

Owing to such an interface with a computer, it is possible to integrate the computer into the game, a game design or a game preparation, for which purpose data are transferred by the computer to the portal unit in one variant. Vice versa, data can be transmitted via the recognized toy to the computer. Using the computer, it is thus possible to plan and influence scenes, to prepare videos and the like. The corresponding prepared data can then be stored in the non-volatile memory of the portal unit and be presented on the display apparatus of the portal unit. This increases the variety of game options of the portal unit and maintains game motivation over a long period of time.

In a continuative configuration, the recording may have a door or a flap for the toy, wherein the toy recognition device is positioned such that toy placed in the receptacle is recognizable.

Such a door or flap can be closed, with the result that the toy behind the door or flap becomes invisible.

In a further continuative configuration, the receptacle may have a lift for the toy, wherein the lift is guided past the toy recognition device in a manner such that the toy recognition device can recognize a toy placed on the lift.

According to one variant, such a lift can be guided on one or more rails in a lift shaft. In various embodiments, the lift can be driven electrically, spring-loaded or exclusively mechanically actuable, which influences not only costs and complexity but also the ease of actuation.

A corresponding lift makes it possible to lower the toy in the interior of the housing of the portal unit.

Owing to the two previously described configurations, the impression of porting the introduced toy to the display apparatus is increased, which can lead to positive surprising effects and emotions in the players.

In one variant, the toy recognition device can be arranged at a movable platform of the lift; in another variant, it can be arranged at the housing in the vicinity of a movement path of the lift.

By arranging the toy recognition device such that a toy positioned in the lift can be recognized, the toy recognition can take place substantially without being noticed by the player.

In another continuative configuration, the toy recognition device can be configured to recognize more than one toy.

For example, it is possible for more than one toy and also for at least one toy and at least one accessory to be recognized at the same time and then be displayed on the display apparatus.

In the context of a lift, the lift can, in one configuration, have at least two or more platforms that are guided past the toy recognition device.

In a further continuative configuration, the receptacle may be arranged on a different side than the display apparatus.

In this way, the construction of the portal unit can be compact and the space required for the display apparatus can be maximized. In addition, the effect of porting is increased, because the playing figure appears to be further away from the virtual playing figure.

In a further continuative configuration, the display apparatus can have a touch-sensitive surface.

A touch-sensitive surface makes it possible to directly interact with the portal unit, for example to move or change the toy on the display apparatus. For this purpose, in various embodiments, the selection of different scenes, the change in the illumination, the addition of specific accessories from a selection or the removal thereof, the adoption of specific poses or positions of the toy or the like can be made possible. These possibilities can be made dependent firstly on the respective toy, and then on different other incentive systems.

In a continuative configuration, portal units that are arranged one next to the other may be in particular wirelessly interconnectable. Such a connection can take the form for example of a Bluetooth connection or a Bluetooth low energy connection. In this way, interaction of the playing figures of two or more portal units that are arranged one next to the other is possible. For example, said playing figures can greet each other with a handshake, can fight one another or the like.

A first independent subject matter relates to a system of at least one portal unit of the previously described type and at least one toy.

Such a toy can be, depending on the embodiment, a playing figure or an accessory for a playing figure. In various configurations, playing figures can be people or animals. An accessory can be, depending on the embodiment, clothing or accessories such as bags, objects such as tools or other objects of everyday life, food or the like. Accessories can also comprise pets of the playing figures, exchangeable hair or the like.

A further independent subject matter relates to a method for using a portable unit of the type described above, wherein a toy is recognized using the toy recognition device, wherein at least one data set assigned to the recognized toy is loaded from the computational unit and a reproduction of a virtual toy corresponding to the recognized toy is displayed using the display apparatus.

In this way, it is possible to present a virtual reproduction of the toy on the display apparatus, wherein the user of the portal unit can interact with the virtual toy.

In a first continuative configuration, a virtual light source may be emulated, wherein a shadow of the virtual toy is displayed on the display device in dependence on the relative position of the virtual light source with respect to the toy.

By using a virtual light source, the holographic effect of the display device can be enhanced.

In a further continuative configuration, a data set identifying the recognized toy may be sent to the computer, wherein at least one game scenario is selected, created and/or processed on the computer, wherein the game scenario is transmitted back to the portal unit and is displayed on the display apparatus.

Using a computer that can have its own display apparatus (display), it is possible to expand the options of the portal unit.

In one possible variant, the computer can be a home computer or a tablet or a smartphone, which is equipped with a corresponding program. A connection can then be established directly between the portal unit and the computer.

In one alternative possible variant, the computer can be a central computer and a connection to the portal unit can be established via remote communication protocols. Updates relating to new figures or game scenes can then be loaded for example via the Internet into the memory of the portal unit.

If a toy placed into the portal unit is not known in the portal unit, it is possible to ascertain information relating to the toy using the toy recognition device and to transmit it to the computer. The latter can then provide data assigned to the toy or retrieve such data from a central computer and transmit them to the portal unit.

In a further continuative configuration, at least one further toy may be recognized and displayed by means of the toy recognition device.

By recognizing at least one further, different toy, it is possible to display more complex scenes on a display apparatus of the portal unit. It is thus possible in some embodiments to place a playing figure and a matching accessory into the portal unit one after the other, to allow for them to be recognized and to use the toys in combination, for example a playing figure and a tool, a playing figure and an item of clothing, or a playing figure and a pet.

In a further continuative configuration, the virtual toy may be displayed such that it is positioned on the at least one visible inner wall.

By positioning it on the at least one visible inner wall, it is possible to create the impression that the virtual toy is located not on the display surface but on the visible inner wall. This enhances the impression of spatial depth.

A further independent subject matter relates to a computer program product having a permanent computer-readable storage medium, on which commands are embedded that, when executed by at least one computational unit, cause the at least one computational unit to be configured to carry out the method of the above-mentioned type.

The method can be carried out distributed over one or more computational units, with the result that specific method steps are performed on one computational unit and other method steps are performed on at least one further computational unit, wherein calculated data can be transmitted between the computational units as necessary.

### BRIEF DESCRIPTION OF THE DRAWINGS

Further features, details and advantages of the invention are apparent from the wording of the claims and from the following description of exemplary embodiments with reference to the drawings.

FIG. 1 generally illustrates a schematic side view of a portal unit;

FIG. 2 generally illustrates a schematic frontal view of the portal unit such as shown in FIG. 1;

FIG. 3 generally illustrates a computer that is connectable to the portal unit such as shown in FIG. 1; and

FIG. 4 generally illustrates different phases of a sequence for porting a playing figure into a portal unit.

### DETAILED DESCRIPTION

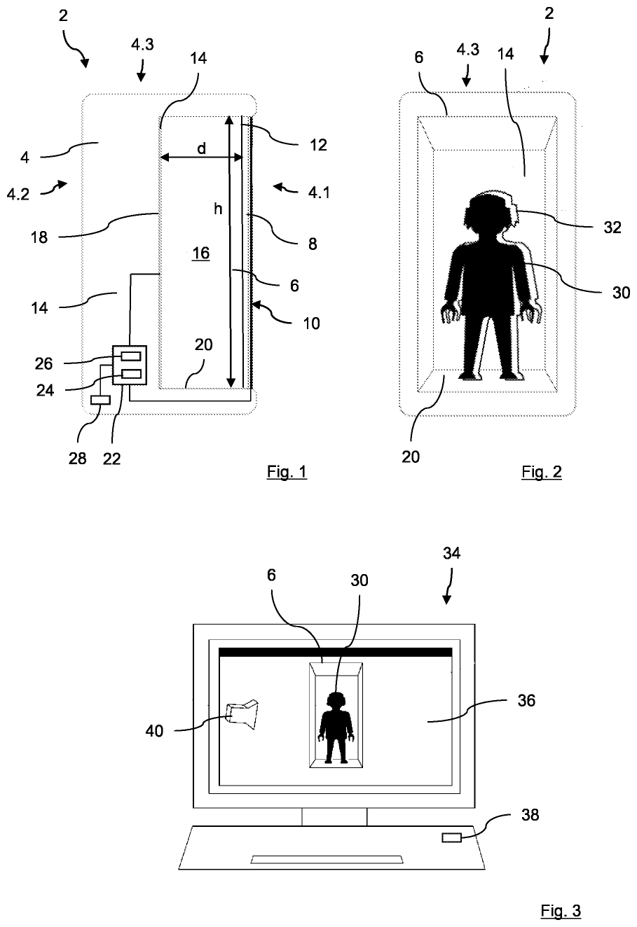

FIG. 1 generally illustrates an embodiment of a portal unit 2.

The portal unit 2 has a housing 4, which is substantially cuboid. A display apparatus 6 is arranged on a front side 4.1.

The display apparatus 6 has a transparent liquid crystal display 8 having a touch-sensitive surface 10. The touch-sensitive surface 10 can have a capacitive design, for example.

A polarization filter 12 is arranged behind the liquid crystal display 8. The polarization filter is switchable and can thus change the transmittance of the background illumination device, with the result that the display apparatus 6 can appear brighter or darker.

A background illumination device 14 is located recessed at a distance d, which in the present case is ⅓ of the height h of the liquid crystal display 8. The background illumination device 14 illuminates the liquid crystal display 8 from the rear. Light emitted by the background illumination device 14 can pass through the liquid crystal display 8 to the outside. In the present case, the background illumination device 14 uses, as the light-emitting means, a matrix of LEDs.

The display apparatus 6 furthermore has an interior space 16 with a rear wall 18, wherein the background illumination device 12 is arranged on the rear wall 16.

The interior space 14 additionally has a bottom 18 that is visible from the outside. The bottom 18 can be incorporated in the presentation and the game play, as is described below.

The portal unit 2 furthermore has a computational unit 22 with a processor 24 and a nonvolatile memory 26. Among other things, an operating system, control programs for the display apparatus 6, a toy recognition device (not illustrated in FIG. 1) and codecs for reading and interpreting image and video data for reproducing such graphical information on the display apparatus 6 are stored in the non-volatile memory 26. Furthermore, a database with compatible toys and accessories and their graphical representation, degrees of freedom, manipulation options and the like are stored.

Furthermore, an interface 28 with a computer (not illustrated in FIG. 1) is provided. The interface 28 in the present case has a wireless design, but can in alternative configurations have a wired design. Various interfaces are also possible, for example USB and WLAN in one configuration.

FIG. 2 shows the portal unit 2 viewed from the front side 4.1.

A playing FIG. 30, which is positioned such that it appears to be standing on the bottom 20, is illustrated on the display apparatus 6. The display apparatus 6 furthermore generates a shadow 32, which enhances a depth effect.

The fact that the display apparatus presents substantially nothing but the playing FIG. 30 and the shadow 32 and the fact that the background illumination device 14 is used in connection with the positioning of the playing FIG. 30 on the display apparatus and of the shadow 32 gives the impression of the playing FIG. 30 being a hologram located in the interior of the interior space 16.

FIG. 3 shows a computer 34.

The computer 34 has a screen 36. Via an interface 38 belonging to the computer 34, it is possible to establish a connection to the interface 28 of the portal unit 2 and to transmit data in both directions between the portal unit 2 and the computer 34.

In addition to the playing FIG. 30, a reproduction of the interior space 16 of the portal unit 2 is displayed on the screen 38 of the computer 34. A virtual light source 40 is additionally presented. The user of the computer 34 can then for example change the position of the virtual light source 40, as a result of which the display apparatus 6 is prompted to adapt the shadow of the virtual playing FIG. 30 accordingly. Furthermore, the light color can be adapted, for example, and further manipulations on the virtual playing FIG. 30, such as dynamic effects and the like, can be performed. It is also possible to conceive and edit videos etc.

The synchronization between the computer 34 and the portal unit 2 can take place simultaneously or with a time lag, with the result that the portal unit 2 can also be used independently of the computer 34 by using the data transmitted by the computer 34.

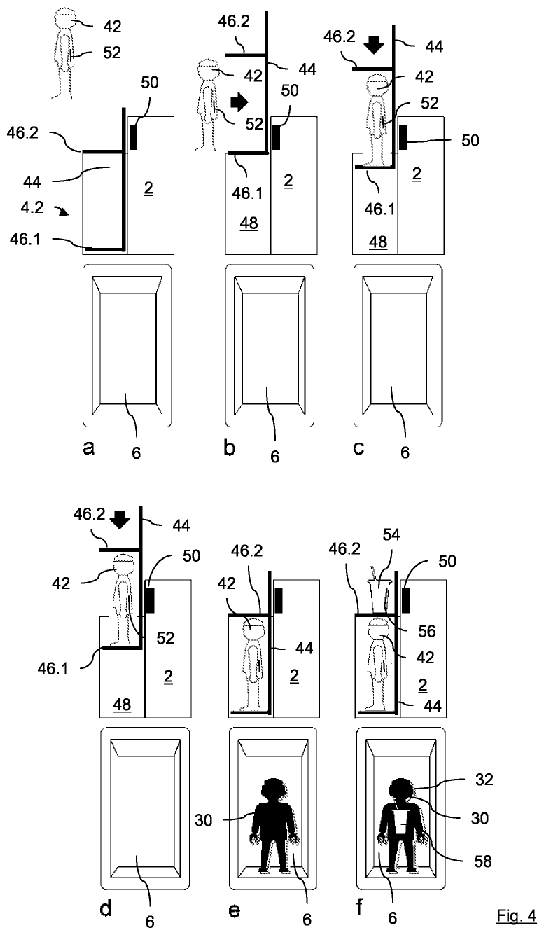

FIG. 4 shows a sequence of the use of the portal unit 2 in connection with a real playing FIG. 42.

FIG. 4 here shows a typical sequence of a method for using the portal unit 2. The upper row in each case shows a sectional side view of the portal unit 2, and the lower row in each case shows a view of the portal unit 2 from the front side 4.1.

Step a) shows the portal unit in an initial state. A lift 44 having two platforms 46.1, 46.2 arranged one above the other is arranged on a side with respect to a rear side 4.2 as a receptacle for the playing FIG. 42. The lift 44 is guided linearly in the vertical direction along rails (not illustrated) and can be pushed out from an upper side 4.3 of the housing 4 of the portal unit 2.

An NFC scanner 50 is arranged on the rear side of the lift 44, in the present exemplary embodiment on a shaft wall of a lift shaft 48 of the lift 44. The NFC scanner 50 is embodied to read an NFC tag 52 of the playing FIG. 42, invisibly located on the playing FIG. 42. In the corresponding method step a), nothing is displayed on the display apparatus 6.

In the method step b), the lift 44 has been moved completely to the top, which means that the lower platform 46.1 is now accessible and can be populated. The playing FIG. 42 can then be placed on the lower platform 46.1.

The NFC tag 52 contains information relating to the type of playing FIG. 42. Each playing figure may have its own identifier, which in some embodiment variants can be unique, and in other embodiment variants can be dependent on the type. For example, different playing figures of the same type can each use the same NFC tag and are thus interchangeable. The use of unique identifiers allows further functions.

In method step d), the lift 44 is moved downwards, and the playing FIG. 42 is thus lowered in the lift shaft 48. In doing so, the NFC tag 52 is guided directly past the NFC scanner 50. The NFC scanner 50 can then read the NFC tag 52 and pass on said information to the computational unit 22.

The computational unit 22 can subsequently evaluate said data. As the playing FIG. 42 is pushed further into the lift shaft 48, the computational unit 22 can load suitable data from the non-volatile memory 26 and process them using the processor 24 to prepare a display of the virtual playing FIG. 30.

Once the playing FIG. 42 has been pushed in completely, as is illustrated in method step e), and the lift 44 is back in its initial position, the display apparatus 6 is activated and the virtual playing FIG. 30 is displayed on the display apparatus 6. To detect that the lift 44 has been pushed in completely, a switch arrangement (not illustrated) may be used for example.

The user of the portal unit 2 is now able to interact with the virtual playing FIG. 30 via the touch-sensitive surface 10 of the display apparatus 6.

Method step f) is optional. The user of the portal unit 2 can position on the other platform 46.2 among other things an accessory, in this case a drinking cup 54, which is likewise provided with an NFC tag 56. Owing to the fact that the upper platform 46.2 is arranged in the vicinity of the NFC scanner 50, the NFC tag 56 is located within the transmitting and receiving range of the NFC scanner 50.

As soon as the NFC scanner 50 has detected that an accessory, here the drinking cup 54, is located on the upper platform 46.2, this information is transmitted to the computational unit 22 and processed by it. Accordingly, a virtual drinking cup 58 appears on the display apparatus 6. The user of the portal unit 2 can then use the virtual drinking cup 58 and incorporate it into the game play.

The invention is not limited to any one of the previously described embodiments but is modifiable in a variety of ways.

All of the features and advantages, including design features, spatial arrangements and method steps, that are derived from the claims, the description and the drawing may be essential to the invention both individually and in a very wide variety of combinations.

1. A portal unit for toys, comprising:
a housing;
a display apparatus arranged at a portion of the housing, the display apparatus having a liquid crystal display and a background illumination device;
a receptacle for at least one toy; and
a toy recognition device;
wherein the liquid crystal display is transparent; wherein the display apparatus forms an interior space, of which at least one inner wall is visible from the outside; and wherein the background illumination device is arranged at a distance from the liquid crystal display on a rear wall of the interior space.

2. The portal unit according to claim 1, wherein the display apparatus has at least one switchable polarization filter.

3. The portal unit according to claim 1, wherein the portal unit has a computational unit for controlling the display apparatus and/or the toy recognition device.

4. The portal unit according to claim 1, wherein the toy recognition device comprises at least one of an NFC scanner, a camera, an optical scanner and/or a near-field communication apparatus.

5. The portal unit according to claim 1, wherein a distance between surfaces that are aligned with respect to one another between the background illumination device and the liquid crystal display is between 1/10 and ¾ or ¼ and ½ or ⅓ of the height of the liquid crystal display.

6. The portal unit according to claim 1, wherein the portal unit has an interface with a computer, via which data are bidirectionally transmittable between the computer and the portal unit.

7. The portal unit according to claim 1, wherein the receptacle has a door or a flap for the toy, wherein the toy recognition device is positioned such that a toy placed in the receptacle is recognizable and/or wherein the receptacle has a lift for the toy, wherein the lift is guided past the toy recognition device such that the toy recognition device can recognize the toy placed on the lift.

8. The portal unit according to claim 1, wherein the receptacle is arranged on a different side than the display apparatus.

9. The portal unit according to claim 1, wherein the display apparatus has a touch-sensitive surface.

10. A system comprising at least one portal unit according to claim 1 and at least one toy.

11. A method for using a portal unit according to claim 1, wherein a toy is recognized using the toy recognition device, at least one data set assigned to the recognized toy is loaded from the computational unit, and a reproduction of a virtual toy corresponding to the recognized toy is displayed using the display apparatus.

12. The method according to claim 11, wherein a virtual light source is emulated, and a shadow of the virtual toy is displayed on the display apparatus based on a relative position of the virtual light source with respect to the toy.

13. The method according to claim 11, wherein a data set identifying the recognized toy is sent to the computer; at least one game scenario is selected, created, or processed on the computer; and the game scenario is displayed on the display apparatus.

14. The method according to claim 11, wherein at least one further toy is recognized and displayed using the toy recognition device.

15. The method according to claim 11, wherein the virtual toy is displayed such that the virtual toy is positioned on the at least one visible inner wall.
